(19) United States
(12) Patent Application Publication
(10) Pub. No.: US 2008/0116845 A1
(43) Pub. Date: May 22, 2008

(54) Arrangement For Charging a Battery of an Underwater Portable Apparatus, Which Prevents Discharge of the Battery When the Apparatus is Underwater

(75) Inventors: Elazar Sonnenschein, Beer-Sheva (IL); Yuval Malka, Beer-Sheva (IL)

Correspondence Address: Kevin D McCarthy;Roach Brown McCarthy and Gruber, 420 Main St, 1620 Liberty Building, Buffalo, NY, 14202, US

(73) Assignee: UNDERWATER TECHNOLOGIES CENTER LTD., Tel Aviv (IL)

(21) Appl. No.: 11/663,933

(22) PCT Filed: Oct. 11, 2005
(86) PCT No.: PCT/IL05/01085

§ 371 Date: Apr. 17, 2007

(30) Foreign Application Priority Data
Oct. 14, 2004 (IL) 164619

(51) Int. Cl. H02J 7/00

(52) U.S. Cl. 320/107

(57) ABSTRACT

The present invention relates to an arrangement in an underwater apparatus having an electronic circuitry, for enabling recharge of the apparatus battery while the apparatus is in recharge state, and for preventing discharge of said battery when the apparatus is in operative state and underwater, the arrangement comprises: (a) connector at the outer sealing of the apparatus with contact points, wherein in a recharging state a charger is connected to said contact points; (b) a first switching device within the apparatus having active and inactive states, wherein in its active state the device connects said contact points to the battery therefore enabling recharge, and in the inactive state the device disconnects said contact points from the battery; and (c) external means for changing the state of the switching device from its active state to its inactive state or vice versa without opening the apparatus sealing.

### FIELD OF THE INVENTION

The present invention relates to the field of underwater battery operated apparatuses. More particularly, the invention relates to a method for charging a battery within a portable waterproof underwater apparatus.

### BACKGROUND OF THE INVENTION

All portable electric underwater apparatuses need an electric power supply that is safe and reliable. Some underwater apparatuses use regular batteries or rechargeable batteries that are inserted into a compartment within the apparatus. Due to the fact that the apparatus is used underwater it is essential that the battery compartment be waterproof. Examples of waterproof battery compartments available on the market today can be seen in underwater photography equipment. The waterproof battery compartment is designed to allow the user access to the battery for replacing or charging. Once the desired operation is concluded the user has to go through a series of actions to ensure that the compartment seal is totally waterproof. After time and usage the seal might lose its effectiveness causing the battery compartment to flood with water while diving, damaging the battery and harming the apparatus. Another solution that can be seen in underwater equipment involves a battery that is concealed within the apparatus itself and protected from water by the apparatus sealing. The underwater apparatus is sold with the concealed battery charged to full and is effective as long as the battery can supply the needed power. Once the battery is drained, the user has to purchase a new apparatus with a charged battery or send the apparatus back to the supplier for replacement of the battery and sealing. This particular solution is advisable only for apparatuses with very low power consumption, like a dive computer, for ensuring prolonged battery power supply. Therefore a solution for power consuming electric underwater apparatuses is needed that is effective, low cost, and applied underwater. Part of the solution can consist of a chargeable battery within the apparatus that has connections to the outer layer of the apparatus, thus enabling the user to charge the battery without damaging the sealing. This kind of solution requires the apparatus to have some kind of outer connectors that can connect the battery concealed within the apparatus with an outer charger. In order to charge the battery the user is required to join the apparatus connectors to a charger before taking the apparatus underwater. A main drawback of this implementation is apparent when the apparatus is taken underwater and met with seawater known to have good conductivity due to high salt level. The conductivity of salt water will form with the apparatus outer connectors a closed electric circuit causing the battery to discharge. A partial solution can be found in sealing the outer connectors with a cork or in covering the connectors with an insulator that will prevent the battery from discharge through seawater. The suggested corks or cover will require the user to unravel the connectors each time the battery needs recharging. Once again the effectiveness of the sealing is compromised by in view of the many closings and unraveling, not to mention a wrong action taken by the user which can totally compromise the sealing of the connectors.

It is therefore an object of the present invention to provide an arrangement for ensuring an effective power supply to portable underwater apparatuses.

It is another object of the present invention to provide means for charging a battery within a portable underwater apparatus without compromising the apparatus sealing.

It is still another object of the present invention to provide the means for charging battery within a portable underwater apparatus without requiring from the user special actions to ensure waterproof.

It is still another object of the present invention to provide a system for charging battery nested within an underwater apparatus, with means that are efficient and accessible to most divers.

It is still another object of the present invention to provide a circuitry that allows charging of a battery within an underwater apparatus and prevent discharge of the battery in seawater.

It is still another object of the present invention to provide a system for downloading or uploading data from within a portable underwater apparatus to an external unit, without compromising the apparatus sealing.

Other objects and advantages of the invention will become apparent as the description proceeds.

### SUMMARY OF THE INVENTION

The present invention relates to an arrangement in an underwater apparatus having an electronic circuitry, for enabling recharge of the apparatus battery while the apparatus is in recharge state, and for preventing discharge of said battery when the apparatus is in operative state and underwater, the arrangement comprises: (a) connector at the outer sealing of the apparatus with contact points, wherein in a recharging state a charger is connected to said contact points; (b) a first switching device within the apparatus having active and inactive states, wherein in its active state the device connects said contact points to the battery therefore enabling recharge, and in the inactive state the device disconnects said contact points from the battery; and (c) external means for changing the state of the switching device from its active state to its inactive state or vice versa without opening the apparatus sealing.

Preferably, the switching device is a relay.

Preferably, the relay further comprises a control port.

Preferably, the control port of the relay is connected to a control point being one of the contact points of the connector, and wherein the means for changing the state of the relay is the charger providing voltage to said control point when the charger is connected to said connector.

Preferably, the relay further disconnects the apparatus circuitry from the battery while the relay is in its active state, and connects the battery to the circuit while the relay is in its inactive state.

Preferably, the battery and circuitry are located within a waterproof casing of the apparatus, and wherein the charger is located external of said casing.

Preferably, the arrangement further enables downloading and/or uploading of data between an external unit and the apparatus circuitry in a data transfer state, by further comprising a second switching device which in its inactive state connects the contact points to said first switch, and disconnects said contact points from data lines of the electronic circuitry, and in its active state disconnects the contact points from said first switch, and connects said contact points to the data lines of the electronic circuitry, and wherein said second switching unit is switched to its active state when the apparatus is in the data state.

Preferably, the second switching device is a second relay.

Preferably, the state of the second switching device is changed from outside the apparatus.

The invention further relates to a method for enabling recharge of an underwater apparatus battery without opening its waterproof casing, while preventing discharge of the battery when the apparatus is underwater, the method comprises: (a) providing a first switching device having an active state and an inactive state; (b) connecting the battery by the first switching device to a charger unit, when the first switching device is in its active state, and disconnecting the battery from the charger when the first switching device is in its inactive state, wherein the battery, first switching device and the apparatus circuitry are within said waterproof casing, and the charger is located external of said casing; and (c) providing means for changing the state of the first switching device from outside the casing.

Preferably the means for changing the state of the switching device is the voltage of the charger unit which is provided to a control port of the switching device.

Preferably the first switching device is a first relay.

The invention further relates to a method for further enabling downloading and/or uploading of data between an external unit and the apparatus circuitry in a data state of the apparatus, by further comprising a second switching device within the casing of the apparatus which in its inactive state connects the contact points to said first switch, and disconnects said contact points from data lines of the electronic circuitry, and in its active state disconnects the contact points from said first switch, and connects said contact points to data lines of the electronic circuitry, and wherein said second switching unit is switched to its active state when the apparatus is in data state.

Preferably the second switching device is a second relay.

### BRIEF DESCRIPTION OF THE DRAWINGS

In the drawings:

FIG. 1 is a block diagram of a circuitry inside a portable underwater device together with a charger, according to an embodiment of the invention; and

FIG. 2 schematically illustrates the inside of the relay, according to an embodiment of the invention; and

FIG. 3 is a block diagram of a circuitry inside a portable underwater device that can transfer data, according to an embodiment of the invention.

### DETAILED DESCRIPTION OF PREFERRED EMBODIMENTS

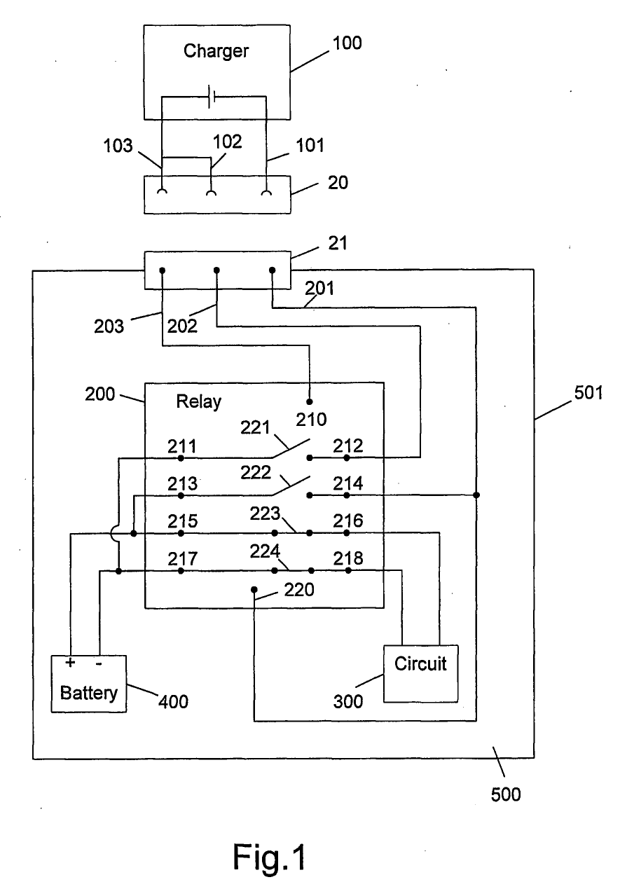

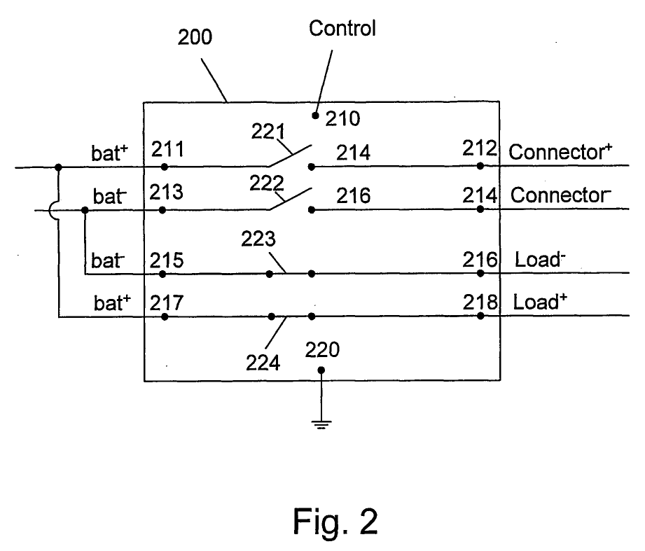

FIG. 1 is a block diagram illustrating a safe charging circuitry of an underwater portable apparatus according to an embodiment of the invention. The main part of the circuitry is the relay 200 which is best illustrated in FIG. 2. The relay is activated by applying voltage potential to the control port 210 while connecting the relay common port 220 to the common connection (−). The relay comprises four switches, 221, 222, 223, and 224. Switches 221 and 222 are normally open (in the inactive state of the relay), and switches 223 and 224 are normally closed. Therefore in the inactive state pin 215 of the relay is connected to pin 216 and pin 217 is connected to pin 218, while pin 211 is disconnected from pin 212 and pin 213 is disconnected from pin 214. In the active state switches 221 and 222 are closed while switches 223 and 224 are open. Similarly pin 215 is disconnected from pin 216 and pin 217 is disconnected from pin 218, while pin 211 is connected to pin 212 and pin 213 is connected to pin 214.

FIG. 1 illustrates that the relay 200 is connected to the battery 400, apparatus circuitry 300 and connector 21. When the relay is in the inactive state, the connector 21 is disconnected from the battery 400 and the battery is connected to the apparatus circuit 300 through the relay switches 223 and 224 allowing the apparatus to function normally. When the relay is transferred to its active state for battery charging, the relay disconnects the battery 400 from the circuit 300 (switches 223 and 224 are open) and reconnects the battery 400 to the connector 21 (switches 221 and 222 are closed). At this stage charging takes place. The connector consists of three contact points, first 201 for common connection (−), second 202 for power to charge the battery (+), and third 203 for controlling the relay. When the charger 100 is connected attaching connector 20 to connector 21, the contact point 203 transfers voltage to relay 200 control port 210 causing the relay to transfer into active state. As said in the active state the relay disconnects the battery 400 from the circuit 300 and connects the battery 400 to the connector 21, thus power from the charger 100 can flow through contact point 102 to contact point 202 through the relay to the battery, while the common contact 101 from the charger 100 is connected to the point 201 which connects through the relay to the battery negative pole resulting in the battery recharging. As long as connectors 20 and 21 are connected, the relay will keep the battery connected to the charger. Once the connectors 20 and 21 are separated and the charger voltage ceases to hold the relay control, all the switches of relay 200 return to their corresponding inactive states, resulting in disconnection of battery 400 from connector 21 and reconnection of battery 400 to circuit 300. At this point the whole apparatus, which is covered by waterproof casing 501 can go underwater. The circuit 300 within the apparatus will receive power from the battery 400 within the apparatus through the relay 200, while the contacts of connector 21 will not discharge the battery 400 in water as it is disconnected from the battery 400 even if they come into contact with the water. In other words, while underwater, the battery and the apparatus circuitry are totally isolated from the charging contacts 201, 202, and 203. On the other hand, during the charging process the battery 400 is connected to the charger 100 and the circuit is disconnected from the battery 400. Therefore, the battery can be charged with no need whatsoever to open the waterproof casing 501. Also, the water cannot affect the battery or the circuitry while underwater.

It should be noted that preferably a resistor of large resistance is added between charging contacts 203 and 201 for the purpose of shorting any potential difference that may occur between said contacts while the battery is not charged. A potential difference between contact point 203 and 201 might affect the relay control port 210 and change the state of the relay inner switches.

In some underwater apparatus data transfer is needed to download information from within the apparatus to an external unit or to upload new programs into the apparatus without burdening the apparatus with too many external contact points, and without leaving the contact points exposed underwater.

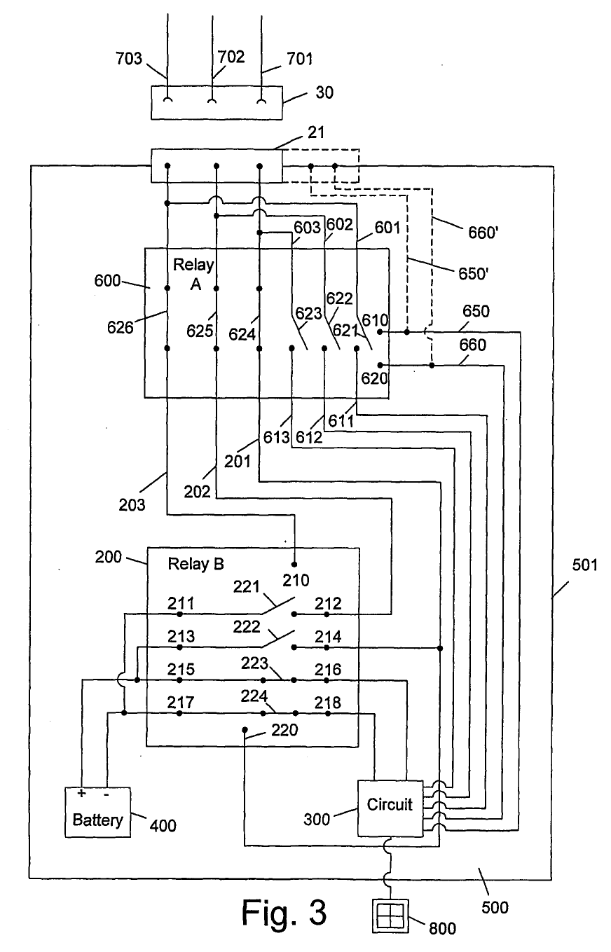

FIG. 3 is a block diagram illustrating an exchange of data between circuitry of an underwater portable apparatus and an external unit such as a PC, according to another embodiment of the invention. For transferring data between circuit 300 and an external unit while the apparatus is not underwater an additional relay 600 is installed between connector 21 and relay 200. In its inactive state the relay 600 switches 624 to 626 are closed forming a direct contact between connector 21 and relay 200 enabling the apparatus to function as described hereinabove, while switches 621 to 623 are open therefore disconnecting data lines 611 to 613 of circuit 300 from connector 21. In its active state the relay 600 switches 624 to 626 are open disconnecting relay 200 from connector 21 and switches 621 to 623 are closed connecting lines 611 to 613 of circuit 300 with connector 21 for enabling data transfer. When Relay 200 is disconnected from connector 21 by relay 600 (switches 624 to 626 are open and switches 621 to 623 are closed) relay 200 is in its inactive state connecting battery 400 with circuit 300, therefore circuit 300 receives power supply from battery 400 as shown. In a first option activation of relay 600 is done by means of circuit 300 which provide voltage to lines 650 and 660 which are connected to relay 600 control port 610 and common contact 620 respectively. Data lines 701 to 703 are used to transfer data from circuit 300 of the apparatus to an external unit or vice versa, where one of the lines provides a clock signal, another line provides the chip select signal, and another line provides the data signal. Once the user transfers the circuit 300 into data mode by using the apparatus buttons 800, the circuit 300 provides voltage between contacts 610 and 620 and transfers relay 600 into its active state. At the active state data lines 701 to 703 are connected to circuit 300 by relay 600 switches 621 to 623 (all in closed state). Once the user transfers the circuit 300 back to normal mode by using the apparatus buttons 800, the circuit 300 terminates the voltage between contacts 610 and 620 and transfers relay 600 into its inactive state. At the inactive state data lines 701 to 703 are disconnected from circuit 300 by relay 600 switches 621 to 623 (all in opened state), while lines 201 to 203 of relay 200 are connected to connector 21 by relay 600 switches 624 to 626 (all in closed state).

In a second option, lines 650 and 660 are connected as additional contacts of connector 21 and referred as 650′ and 660′ respectively, instead of being connected to circuit 300, as shown in FIG. 3. Therefore, relay 600 can be controlled from connector 21. In that case connector 21 has five connection points, three for data and two for controlling the state of the relay (by providing voltage between said two control contacts, in a similar manner as described with respect to FIG. 1).

It should be noted that preferably a resistor of large resistance is added between lines 650 and 660 for the purpose of shorting any potential difference that may occur between said contacts while the circuit is turned off. A potential difference between lines 650 and 660 might affect the relay control port 610 and change the state of the relay inner switches.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. Arrangement in an underwater apparatus having an electronic circuitry, for enabling recharge of the apparatus battery while said apparatus is in recharge state, and for preventing discharge of said battery when the apparatus is in operative state and underwater, comprising:
a. connector at the outer sealing of the apparatus with contact points, wherein in a recharging state a charger is connected to said contact points;
b. a first switching device within the apparatus having active and inactive states, wherein in its active state the device connects said contact points to the battery therefore enabling recharge, and in the inactive state the device disconnects said contact points from the battery; and
c. external means for changing the state of the first switching device from its active state to its inactive state or vice versa without opening the apparatus sealing.

2. Arrangement according to claim 1 wherein the first switching device is a first relay.

3. Arrangement according to claim 2 wherein the first relay further comprises a control port.

4. Arrangement according to claim 3 wherein the control port of the first relay is connected to a control point being one of the contact points of the connector, and wherein the means for changing the state of the first relay is the charger providing voltage to said control point when the charger is connected to said connector.

5. Arrangement according to claim 2 wherein the first relay further disconnects the apparatus circuitry from the battery while the relay is in its active state, and connects the battery to the circuit while the relay is in its inactive state.

6. Arrangement according to claim 1 wherein the battery and circuitry are located within a waterproof casing of the apparatus, and wherein the charger is located external of said casing.

7. Arrangement according to claim 1, for further enabling downloading and/or uploading of data between an external unit and the apparatus circuitry in a data state, further comprising:
d. a second switching device which in its inactive state connects the contact points to said first switch, and disconnects said contact points from data lines of the electronic circuitry, and in its active state disconnects the contact points from said first switch, and connects said contact points to data lines of the electronic circuitry, and wherein said second switching unit is switched to its active state when the apparatus is in data transfer state.

8. Arrangement according to claim 7, wherein the second switching device is a second relay.

9. Arrangement according to claim 7, wherein the state of the second switching device is changed from outside the apparatus.

10. Method for enabling recharge of an underwater apparatus battery without opening its waterproof casing, while preventing discharge of the battery when the apparatus is underwater, comprising:
a. providing a first switching device having an active state and an inactive state;
b. connecting the battery by the first switching device to a charger, when the first switching device is in its active state, and disconnecting the battery from the charger when the first switching device is in its inactive state, wherein the battery, first switching device and the apparatus circuitry are within said waterproof casing, and the charger is located external of said casing; and
c. providing means for changing the state of the first switching device from outside the casing.

11. Method according to claim 10, wherein the means for changing the state of the first switching device is the voltage of the charger which is provided to a control port of the switching device.

12. Method according to claim 10 wherein the first switching device is a first relay.

13. Method according to claim 10, for further enabling downloading and/or uploading of data between an external unit and the apparatus circuitry in a data state of the apparatus, further comprising:
d. Providing a second switching device within the casing of the apparatus which in its inactive state connects the contact points to said first switch, and disconnects said contact points from data lines of the electronic circuitry, and in its active state disconnects the contact points from said first switch, and connects said contact points to data lines of the electronic circuitry, and wherein said second switching unit is switched to its active state when the apparatus is in data state.

14. Method according to claim 13 wherein the second switching device is a second relay.
